(19) United States
(12) Patent Application Publication
(10) Pub. No.: US 2023/0010334 A1
(43) Pub. Date: Jan. 12, 2023

(54) SYSTEM AND METHOD FOR IMPLEMENTING A SEARCH ENGINE ACCESS POINT ENHANCED FOR RETAILER BRAND SUGGESTED LISTING NAVIGATION

(71) Applicant: The Literal Company, Valley Cottage, NY (US)

(72) Inventors: Yan Tsirklin, Valley Cottage, NY (US); Barry Meyer, Framingham, MA (US); Kurt Streed, Minneapolis, MN (US)

(73) Assignee: The Literal Company, Valley Cottage, NY (US)

(21) Appl. No.: 17/454,541

(22) Filed: Nov. 11, 2021

Related U.S. Application Data
(60) Provisional application No. 63/219,605, filed on Jul. 8, 2021.

(51) Int. Cl. G06Q 30/06; G06Q 30/02

(52) U.S. Cl. CPC G06Q 30/0631; G06Q 30/0205; G06Q 30/0643; G06Q 30/0629

(57) ABSTRACT

A method for determining and displaying suggested search results includes executing a query on a keyword database to identify a plurality of matching keywords based on the received input string, and to identify the value of each keyword and the relevance of each matching keyword to the received input string, executing a query on a bidding database to identify a plurality of bids based on the identified matching keywords, identifying rank values of the matching keywords by performing a predetermined mathematical operation involving the value of each respective keyword and its relevance to the received input string, determining a highest ranked keyword based on the identified rank values, and a retailer specific search result based on the identified bids and the highest ranked keyword, and displaying the retailer specific search result.

### CROSS-REFERENCES TO RELATED APPLICATIONS

The present application claim the benefit of U.S. Provisional Application No. 63/219,605 filed Jul. 8, 2021, the entire content of which is incorporated by reference herein.

### FIELD OF THE INVENTION

The present invention relates generally to systems and methods for searching and navigating to brand specific content on a retailer's ecommerce site.

### BACKGROUND

In recent years, E-commerce has become a dominant domain for consumer goods transactions. Websites run by such businesses typically include search engines allowing potential customers to browse available products. It is generally known that certain products, often for reasons of financial benefit to the e-commerce vendor, can be displayed above and beyond their objective relevancy in a particular search, but these promotion algorithms are relatively inflexible and come nowhere near maximizing the potential for monetization of search content.

### SUMMARY

A method for determining and displaying suggested search results includes storing, in a keyword database of a processing server, a plurality of keyword profiles, wherein each keyword profile is a structured data set configured to store data related to a value of the keyword and the relevance of the keyword to a plurality of input strings, storing, in a bidding database of the processing server, a plurality of bidding profiles, wherein each bidding profile is a structured data set configured to store data related to a bid on a keyword, receiving, by a receiving device of the processing server, an input string inputted by a user, executing, by a querying module of the processing server, a query on the keyword database to identify a plurality of matching keywords based on the received input string, and to identify the value of each keyword and the relevance of each matching keyword to the received input string, executing, by the querying module of the processing server, a query on the bidding database to identify a plurality of bids based on the matching keywords identified by the querying module, identifying, by a data identification module of the processing server, rank values of the matching keywords by performing a predetermined mathematical operation involving the value of each respective keyword and its relevance to the received input string, determining, by an analytical module of the processing server, a highest ranked keyword based on the rank values identified by the data identification module, and a retailer specific search result based on the bids identified by the querying module and the highest ranked keyword, and electronically transmitting, by a transmitting device of the processing server, the retailer specific search result determined by the analytical module for display on a display.

A system for determining and displaying suggested search results includes a keyword database of a processing server configured to store a plurality of keyword profiles, wherein each keyword profile is a structured data set configured to store data related to a value of the keyword and the relevance of the keyword to a plurality of input strings, a bidding database of the processing server configured to store a plurality of bidding profiles, wherein each bidding profile is a structured data set configured to store data related to a bid on a keyword, a receiving device of the processing server configured to receive an input string inputted by a user, a querying module of the processing server configured to execute a query on the keyword database to identify a plurality of matching keywords based on the received input string, and to identify the value of each keyword and the relevance of each matching keyword to the received input string, and to execute a query on the bidding database to identify a plurality of bids based on the matching keywords identified by the querying module, a data identification module of the processing server configured to identify rank values of the matching keywords by performing a predetermined mathematical operation involving the value of each respective keyword and its relevance to the received input string, an analytical module of the processing server configured to determine a highest ranked keyword based on the rank values identified by the data identification module, and a retailer specific search result based on the bids identified by the querying module and the highest ranked keyword, and a transmitting device of the processing server configured to electronically transmit the retailer specific search result determined by the analytical module for display on a display.

### BRIEF DESCRIPTION OF THE DRAWINGS

FIG. 1 is a schematic flow chart illustrating a user interface and an exemplary comparison of input text to targeted keywords.

FIG. 2 is a schematic flow chart illustrating an exemplary autocomplete based on the FIG. 1 exemplary comparison.

FIG. 3 is a schematic flow chart illustrating another exemplary autocomplete based on the FIG. 1 exemplary comparison.

FIG. 4 is a block diagram illustrating an exemplary keyword database.

FIG. 5 is a block diagram illustrating an exemplary processing server employing the FIG. 4 keyword database to implement the methods of FIGS. 1-3.

FIG. 6 is a flow diagram illustrating the methods of FIGS. 1-3.

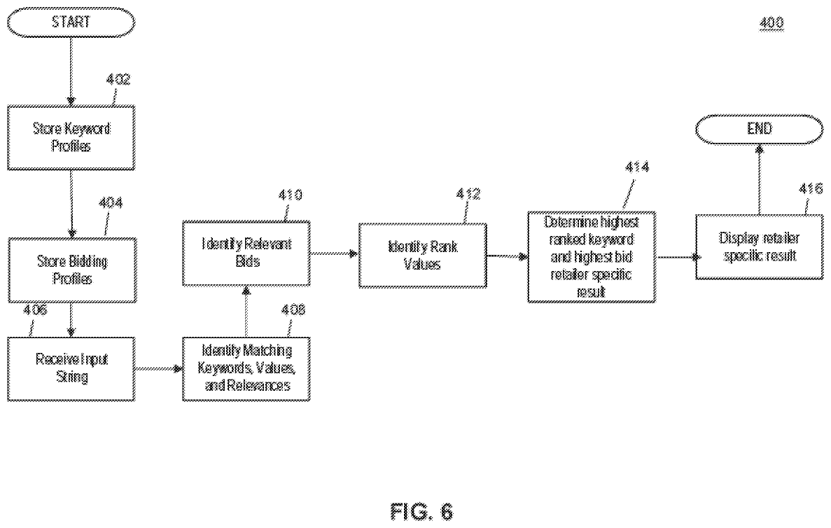

FIG. 7 is a block diagram illustrating a computer system architecture in accordance with exemplary embodiments.

### DETAILED DESCRIPTION

Set forth below with reference to the accompanying drawings is a detailed description of embodiments of a system and method for implementing a search engine access point enhanced for retailer brand suggested listing navigation, representing examples of an inventive system and method for implementing a search engine access point enhanced for retailer brand suggested listing navigation.

Embodiments of the present application use identified target keywords, as well as supplier bids on various keywords, to determine when to display retailer brand suggested search results, and which such retailer results are to be displayed. In this way, the retailer can more effectively netize search results targeted to certain brands. Discussed below are exemplary implementations of such a system and method.

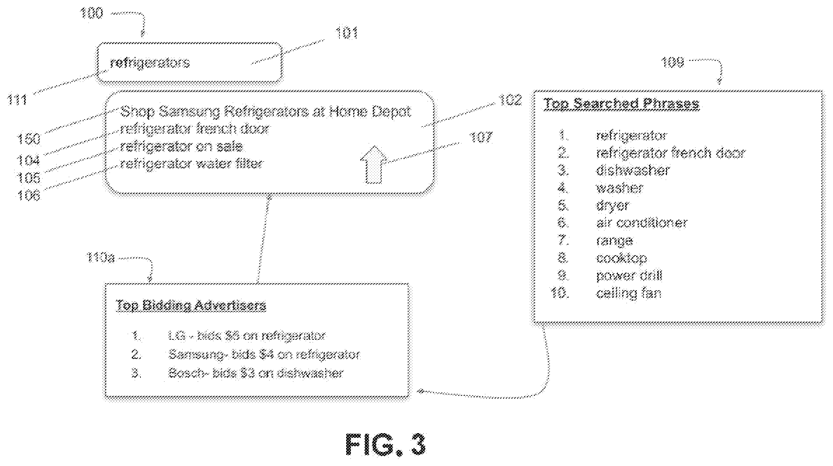

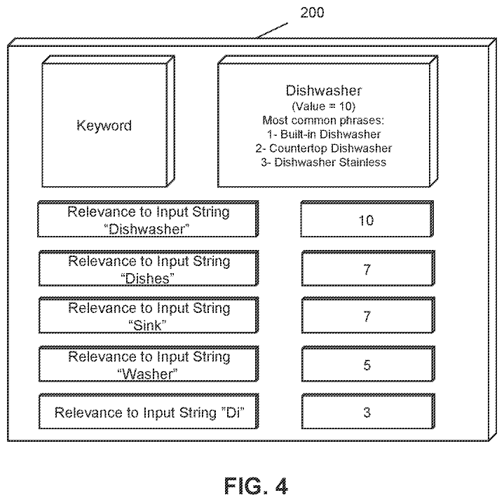

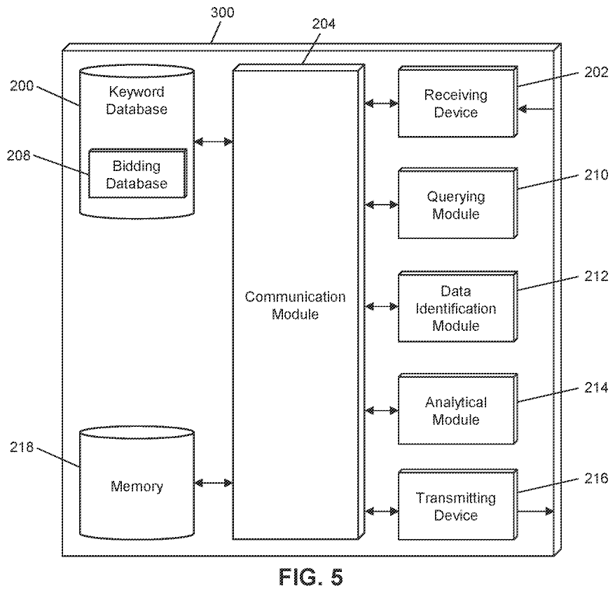

As illustrated in FIGS. 4, and 5, a processing server 300 includes a keyword database 200 in which are stored various keywords, which are associated with various possible input text strings by a relevance score. In the FIG. 4 example, the keyword “dishwasher” is very relevant to the inputted text “dishwasher”, less relevant to “sink” and “dishes”, further less relevant to “washer”, etc. Thus, for example, if “dishwasher” is the input text, the keyword “dishwasher” will have a relevance score of 10 for that search, whereas if “dishes” is the input text, the keyword “dishwasher” will have a relevance score of 7 for that search, etc. Keywords are also associated with apparent partial inputs, although generally with lower scores. For example, the input “dis” might be associated as well with the keyword “dishwasher”, albeit with a lower score, e.g., 3. In this case “dishwasher” might still be the highest keyword associated with the input, even with a relatively low score of 3. As also illustrated in FIG. 3, the keyword database 200 also assigns a value to each keyword that is independent of the particular input. For example, the value can be at least in part associated with the overall frequency with which that keyword is searched. In the FIG. 4 example, “dishwasher” is assigned a value of 10, and so, for example, a less common keyword such as “pump” will have assigned a lower value, for example, 3. As also illustrated in FIG. 4, for each keyword, the most common phrases employing the keyword are associated therewith (in the example, “Built-In Dishwasher”, “Countertop Dishwasher”, and “Dishwasher Stainless”). The database of course includes a large number of keywords and possible input texts and so FIG. 4 clearly illustrates a only small subset of the database.

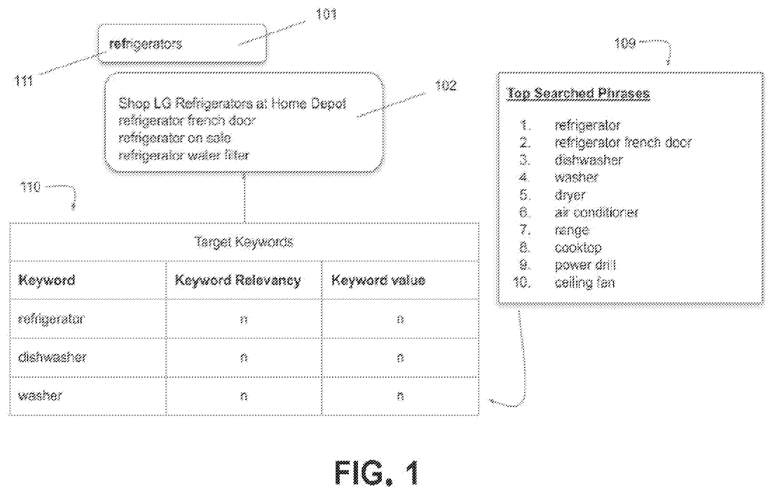

The processing server 300 is configured to communicate with an end-user interface, illustrated in FIG. 1, which is a display including an input text box 101, into which a user can enter an input string, and an output text box 102 which displays several possible user-selectable searches to the user. FIG. 1 also illustrates a comparison of input text 111 that has been inputted into a text box 101, to an internal list of targeted keywords 110, which is performed by the processing server 300 as discussed in detail below. The targeted keywords are listed based on the above-discussed keyword relevancy and a keyword value that, as discussed above, is at least partially influenced by top searched phrases 109. For example, in the FIG. 4 embodiment, “dishwasher” has a keyword value of 10, as it appears very often in searches. The top-searched phrases 109 and list or targeted keywords 110 is schematically illustrated in FIG. 1, but are not part of the user display.

As discussed above, the targeted keywords are ranked by determining a rank value in an operation using both the keyword relevancy and the keyword value. For example, the keyword relevancy and value are simply added in an embodiment, but could instead by multiplied, or a more complicated equation used, to determine the rank value. In FIG. 1, since the keyword refrigerator is highly relevant to the input “refrigerator”, and also has a high value, it appears first in the list 110.

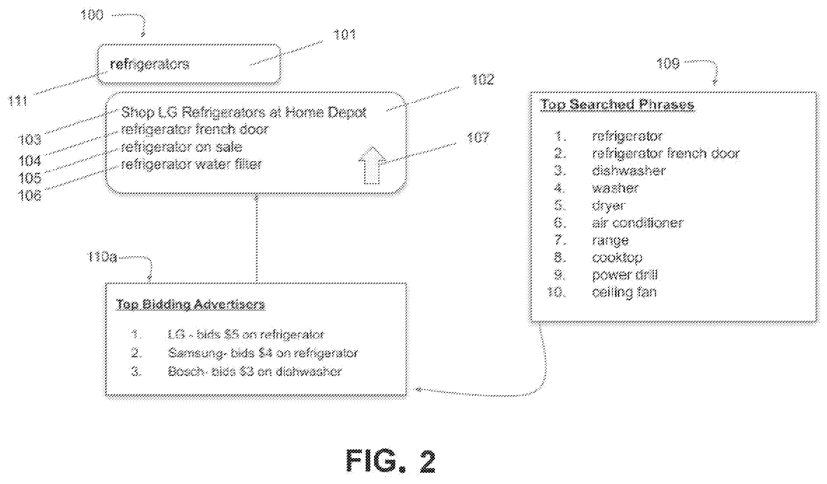

In the text box 102 are listed the highest-ranked keyword (if not the same as the input string), as well as a number of suggested searches based on the highest-ranked keyword (in the embodiment, three suggested searches as well as a brand-specific search that is displayed under certain conditions, which will be discussed in detail below). Of course, the number of suggested searches could be varied. The suggested searches (aside from the brand-specific searches) can be taken, for example, by a portion of the database which associates each keyword with the most common phrases using the keyword. For example, as shown in FIG. 2, for the keyword “refrigerators”, the most common phrases in the database are “refrigerator French door” 104, “refrigerator on sale” 105, and “refrigerator water filter” 106, and so they appear as suggested searches (in the embodiment, they most common phrases for each keyword are included in the keyword database 200, as discussed above). The user may utilize a mouse pointer 107 to select a suggested advertising result, or could also simply hover over a suggested advertising result and press the enter button on their keyboard to select the hovered term as their operative input. Those skilled in the art will appreciate that arrow keys on a keyboard can also be used to select one of the suggested advertising results.

The processing server 300 also includes a bidding database 208 which includes data on top bidding advertisers for particular keywords. For example, as shown in FIG. 2, which schematically illustrates a portion 110A of the bidding database 208 (although not actually displayed), the top bidding advertiser for the top-ranked keyword “refrigerator”(as illustrated in FIG. 1) is LG. Accordingly, in the embodiment, in text box 102, when certain conditions are met, a search result of “Shop LF Refrigerators at Home Depot” 103 will be displayed, which will take the user directly to the portion of the retailer website associated with LF refrigerators. The retailer specific suggested result will be displayed when a certain confidence threshold is met, for example, when the rank value of the keyword (which is calculated as discussed above) of the keyword from which display results are determined (in the embodiment, the highest-ranked keyword) is at or above a certain threshold. In the example, the second-highest bidder, LG, was outbid for the keyword, and Bosch has only bid on a different keyword, and so neither Samsung nor Bosch products are provided with a link in the search results. The retailer specific suggested result will be displayed in place of the keyword, if the keyword itself would ordinarily be displayed, for example, because it differs from the input text string. Otherwise, the retailer specific suggested result will simply be added to the list of suggested searches.

FIG. 3 illustrates a modified example which takes into account a user's location determined by, for example, the user entering their zip code when logging on to the retailer site, or by the IP address of the user. In the embodiment, Home Depot stores in the region that serve the user's zip code do not carry LG refrigerators but do carry Samsung refrigerators and so, despite being outbid, the term “Shop Samsung Refrigerators at Home Depot” 105 will be displayed. The highest bid brand may also be negated if, for example, the second-highest bid brand is much more popular than the highest bidders in the region.

In additional embodiments, a premium may be paid by the bidders to distance themselves from the competition (i.e., make their terms more “relevant” for matching purposes). For example, the top bidder LG in the FIG. 2 example could have placed a distance bid of $2 on a particular search term or stem. In this example, the top bidder's competition would be knocked down by at least one position if the competitor did not also place a distance bid themselves. In cases where more than one bidder placed a distance bid on a particular word, phrase, or stem, the top bidding distance bid combined with the top bidder for the search term may prevail.

In other embodiments, keywords are identified influenced by a user's previous behavior. For example, the processing server 300 may cross reference the key words found from the previous searches with pre-bid terms. Terms that have the highest bid that correlate with a user's previous keyword searches may be boosted in the search results.

In further embodiments, the processing server 300 may identify keywords based on a user's typing speed. In this embodiment, the processing server 300 may cross reference typing speed and previous searches with pre-bid terms. Terms that have the highest bid that correlate with other user's based on typing speed of similar keyword searches and subsequently become boosted in the search results.

The processing server 300 may utilizes a dynamic or non-fixed Artificial Intelligence Machine Learning algorithm, such as but not limited to an ensemble learning or federated learning approach, utilizing a general mix of many other factors influencing the likelihood of a product or service being sold or promoted include but are not limited to demographic, such as data that is immutable within a session, behavioral such as recent actions or decisions made by a user, or partner information such as data shared by a third party, for example a different website which a user might be currently logged into which has a data sharing agreement authorizing the exchange of information.

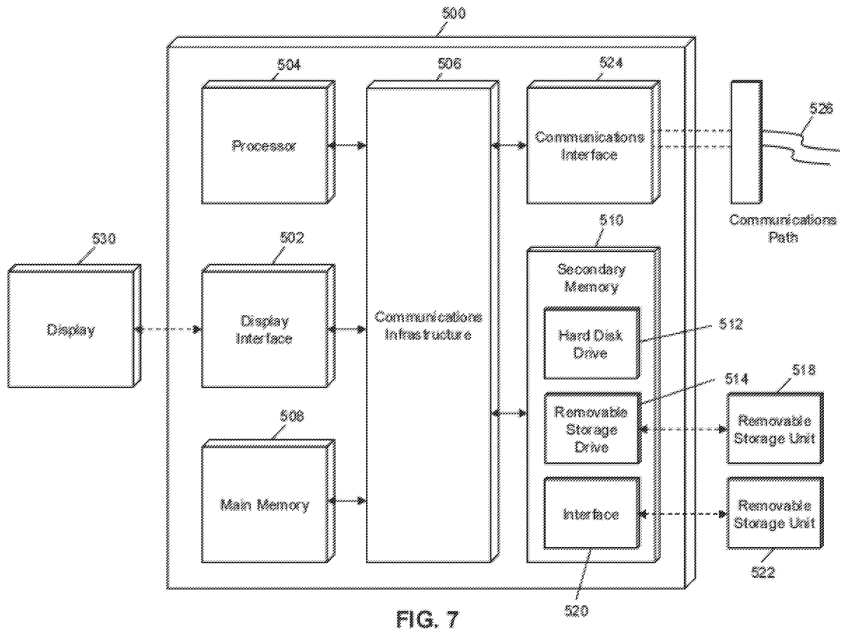

As illustrated in FIG. 5, in the embodiment, the processing server 300 includes the keyword database 200, which includes the keyword's value, the most common searches including the keyword, and the keyword's relevancy to various inputs, as illustrated in FIG. 4, as well as a bidding database 208 which includes bidding information such as illustrated in portion 110A of FIGS. 2 and 3. In this regard, it will be apparent to persons having skill in the relevant art that the embodiment of the processing server 300 illustrated in FIG. 5 is provided as illustration only and may not be exhaustive to all possible configurations of the processing server 300 suitable for performing the functions as discussed herein. For example, the computer system 500 illustrated in FIG. 7 and discussed in more detail below may be a suitable configuration of the processing server 300.

The processing server 300 further includes a receiving device 202. The receiving device 202 may be configured to receive data over one or more networks via one or more network protocols. In some instances, the receiving device 202 may be configured to receive input search string data from the user as input into the input text box 102, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by a processing device (described below) to carry out the methods and systems described herein.

The processing server 300 further includes a communication module 204. The communication module 204 may be configured to transmit data between modules, engines, databases, memories, and other components of the processing server 300 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 300 and external components of the processing server 300, such as externally connected databases, display devices, input devices, etc. The processing server 300 may also include a processing device. The processing device may be configured to perform the functions of the processing server 300 discussed herein as will be apparent to persons having skill in the relevant art. In some embodiments, the processing device may include and/or be comprised of a plurality of engines and/or modules specially configured to perform one or more functions of the processing device, such as a querying module 210, data identification module 212, analytical module 214, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 300 may include a querying module 210. The querying module 210 may be configured to execute queries on databases to identify information. The querying module 210 may receive one or more data values or query strings, and may execute a query string based thereon on an indicated database, such as the keyword database 200 and the bidding database 208, to identify information stored therein. The querying module 210 may then output the identified information to an appropriate engine or module of the processing server 300 as necessary. The querying module 210 may, for example, execute a query on the keyword database 200 to identify matching keywords, and their relevancy and value, for a given input search string received by the receiving device 202, and a query on the bidding database 208 to identify a plurality of matching bids based on the identified matching keywords.

The processing server 300 may also include a data identification module 212. The data identification module 212 may be configured to identify data for the processing server 300 for use in performing the functions discussed herein. The data identification module 212 may receive instructions as input, may identify data as instructed, and may output the identified data to another module or engine of the processing server 300. For example, the data identification module 212 may be configured to receive a list of keywords, their values, and their relevancies to a particular search string and identify the rank values of the matching keywords relative to particular search string by performing a predetermined mathematical operation involving the value of the each respective keyword its and relevancy to the input string. As discussed above, exemplary mathematical operations to determine the rank value can involving summing the value and the relevance to determine

The processing server 300 may further include an analytical module 214. The analytical module 214 may be configured to analyze data as part of the processes of the processing server 300 discussed herein. The analytical module 214 may receive instructions as input, may perform analysis as instructed, and may output a result of the analysis to another module or engine of the processing server 300. In some cases, the instructions may include data to be analyzed by the analytical module 214. In other cases, the analytical module 214 may be configured to identify the data to be used in the requested analysis. The analytical module 214 may be configured to, for example, receive a list of targeted keywords, their respective rank values, the bidding information of advertisers that have bid on the targeted keywords, and the location information of the user, and determine whether one or more retailer specific search results should be displayed, and if so, where in the list of suggested searches those results should be displayed.

The processing server 300 may also include a transmitting device 216. The transmitting device 216 may be configured to transmit data over one or more networks via one or more network protocols. In some instances, the transmitting device 216 may be configured to transmit data to the output text box 102, and other entities via one or more communication methods, local area networks, wireless area networks, cellular communication, Bluetooth, radio frequency, the Internet, etc. In some embodiments, the transmitting device 216 may be comprised of multiple devices, such as different transmitting devices for transmitting data over different networks, such as a first transmitting device for transmitting data over a local area network and a second transmitting device for transmitting data via the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission. The transmitting device 2116 can, for example, transmit suggested search results including retailer-specific search results to the output text box 102.

The processing server 300 may also include a memory 218. The memory 218 may be configured to store data for use by the processing server 300 in performing the functions discussed herein, such as public and private keys, symmetric keys, etc. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the processing server 300 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein. The memory 218 may be configured to store, for example, algorithms for ranking suggested search results, etc.

FIG. 4 illustrates a flow chart of a method 400 for the determining and displaying suggested search results according to embodiments. In step 402, a plurality of keyword profiles are stored in the keyword database 200 of the processing server 300, wherein each keyword profile is a structured data set configured to store data related to a value of the keyword and the relevance of the keyword to a plurality of input strings. In step 404, a plurality of bidding profiles are stored in the bidding database 208 of the processing server 300, wherein each bidding profile is a structured data set configured to store data related to a bid on a keyword. In step 406, the receiving device 202 of the processing server 300 receives an input string inputted by the user at the input text box 101.

In step 408, the querying module 210 of the processing server 300 executes a query on the keyword database 200 to identify a plurality of matching keywords based on the received input string, and to identify the value of each keyword and the relevance of each matching keyword to the received input string. In step 410, the querying module 210 of the processing server 300 executes a query on the bidding database 208 to identify a plurality of bids based on the matching keywords identified by the querying module 210. In step 412, the data identification module 212 of the processing server 300 identifies rank values of the matching keywords by performing a predetermined mathematical operation involving the value of each respective keyword and its relevance to the received input string. In step 414, the analytical module 214 of the processing server 300 determines a highest ranked keyword based on the rank values identified by the data identification module 212, and a retailer specific search result based on the bids identified by the querying module 210 and the highest ranked keyword. In step 416, the transmitting device 216 of the processing server 300 electronically transmits the retailer specific search result determined by the analytical module 214 for display on the output text box 102.

FIG. 7 illustrates a computer system 500 in which embodiments of the present disclosure, or portions thereof, may be implemented as computer-readable code. For example, the processing server 300 of FIG. 5 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods discussed herein.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

The detailed description above describes embodiments of a system and method for implementing a search engine access point enhanced for retailer brand suggested listing navigation. The invention is not limited, however, to the precise embodiments and variations described. Various changes, modifications and equivalents can be effected by one skilled in the art without departing from the spirit and scope of the invention as defined in the accompanying claims. It is expressly intended that all such changes, modifications and equivalents which fall within the scope of the claims are embraced by the claims.

What is claimed is:

1. A method for determining and displaying suggested search results, comprising:
storing, in a keyword database of a processing server, a plurality of keyword profiles, wherein each keyword profile is a structured data set configured to store data related to a value of the keyword and the relevance of the keyword to a plurality of input strings;
storing, in a bidding database of the processing server, a plurality of bidding profiles, wherein each bidding profile is a structured data set configured to store data related to a bid on a keyword;
receiving, by a receiving device of the processing server, an input string inputted by a user;
executing, by a querying module of the processing server, a query on the keyword database to identify a plurality of matching keywords based on the received input string, and to identify the value of each keyword and the relevance of each matching keyword to the received input string;
executing, by the querying module of the processing server, a query on the bidding database to identify a plurality of bids based on the matching keywords identified by the querying module;
identifying, by a data identification module of the processing server, rank values of the matching keywords by performing a predetermined mathematical operation involving the value of each respective keyword and its relevance to the received input string;
determining, by an analytical module of the processing server, a highest ranked keyword based on the rank values identified by the data identification module, and a retailer specific search result based on the bids identified by the querying module and the highest ranked keyword; and
electronically transmitting, by a transmitting device of the processing server, the retailer specific search result determined by the analytical module for display on a display.

2. The method of claim 1, wherein the analytical module determines the highest ranked keyword based additionally on location data of the user.

3. A system for determining and displaying suggested search results, comprising:
a keyword database of a processing server configured to store a plurality of keyword profiles, wherein each keyword profile is a structured data set configured to store data related to a value of the keyword and the relevance of the keyword to a plurality of input strings;
a bidding database of the processing server configured to store a plurality of bidding profiles, wherein each bidding profile is a structured data set configured to store data related to a bid on a keyword;
a receiving device of the processing server configured to receive an input string inputted by a user;
a querying module of the processing server configured to execute a query on the keyword database to identify a plurality of matching keywords based on the received input string, and to identify the value of each keyword and the relevance of each matching keyword to the received input string, and to execute a query on the bidding database to identify a plurality of bids based on the matching keywords identified by the querying module;
a data identification module of the processing server configured to identify rank values of the matching keywords by performing a predetermined mathematical operation involving the value of each respective keyword and its relevance to the received input string;
an analytical module of the processing server configured to determine a highest ranked keyword based on the rank values identified by the data identification module, and a retailer specific search result based on the bids identified by the querying module and the highest ranked keyword; and
a transmitting device of the processing server configured to electronically transmit the retailer specific search result determined by the analytical module for display on a display.

4. The system of claim 3, wherein the analytical module determines the highest ranked keyword based additionally on location data of the user.
